(19) United States
(12) Patent Application Publication
(10) Pub. No.: US 2011/0302772 A1
(43) Pub. Date: Dec. 15, 2011

(54) Pedal and Peg Tool

(76) Inventor: Ronald Moody, Tooele, UT (US)

(21) Appl. No.: 13/153,536

(22) Filed: Jun. 6, 2011

Related U.S. Application Data
(60) Provisional application No. 61/352,949, filed on Jun. 9, 2010.

(51) Int. Cl. B23P 19/00

(52) U.S. Cl. 29/700

(57) ABSTRACT

An architecture is presented that provides an improved tool for installing, adjusting and removing pedals and pegs for bicycles and the like. The improved tool comprises a handle portion and a head portion. The head portion further comprises a cutout portion with a tab for receipt of a peg and an opening for receipt of a pedal nut, while the handle portion facilitates easy and secure handling of the improved tool.

### CROSS-REFERENCE

This application claims priority from Provisional Patent Application Ser. No. 61/352,949 filed Jun. 9, 2010.

### BACKGROUND

Unicycles, bicycles, tricycles and the like have been around for hundreds of years, and bicycling in particular is a popular sport enjoyed by people of all ages. Many people are involved in competitive bicycling, while many more use bicycling as a means of exercise, while others still enjoy bicycling as a recreational activity.

In order to fully and safely enjoy the cycling experience, it is important that the user utilize the proper equipment including, without limitation, an appropriately suited cycle, such as a bicycle, a helmet, rear view mirrors and appropriate attire. It is also important for the user to properly maintain and care for his or her cycle. In caring for a cycle, such as a bicycle, it is oftentimes necessary for the user to install, adjust or remove components of the bicycle including the bicycle pedals and pegs, which are well known in the art and widely used. Similarly, cycle builders, racing teams, cycle maintenance personnel and the like also have to periodically install, replace, adjust and/or remove bicycle pedals and pegs.

Historically, a specific tool for installing, replacing, adjusting and/or removing bicycle pedals and pegs did not exist, and individuals had to rely upon more common tools such as wrenches and the like to perform these tasks. In addition, it is oftentimes necessary to have multiple tools to perform these tasks. For example, a user may have one tool for installing, replacing, adjusting and/or removing bicycle pedals and a second tool for installing, replacing, adjusting and/or removing bicycle pegs. Having to maintain and carry multiple tools can be cumbersome and time consuming, and can effect the outcome of a competitive cycling event.

Moreover, because these more common tools, such as wrenches and the like, are not specifically manufactured for these tasks, such tools are inefficient, difficult and time-consuming to use. For example, traditional wrenches may need to be adjusted each time they are used to properly accommodate the size or orientation of the bicycle pedal and/or peg. Moreover, in a competitive racing environment, not having the proper tool readily available to install, replace, adjust of remove a bicycle pedal or peg can cost the rider precious time and result in the rider being less competitive than his or her competition.

Consequently, there exists in the art a long-felt need for a single tool for installing, replacing, adjusting and/or removing bicycle pedals and pegs in a safe and efficient manner. There also exists a long-felt need for a tool for installing, replacing, adjusting and/or removing bicycle pedals and pegs that is relatively easy and inexpensive to manufacture and use. The tool of the present invention provides a user with a single, relatively lightweight and easy to use device for installing, replacing, adjusting and/or removing pedals and pegs on a cycle, such as a unicycle, bicycle, tricycle and the like. The tool of the present invention can be used by all cycling enthusiasts, amateur and professional, regardless of age or physical characteristics, and can be readily and easily transported with a cycle or the cyclist.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a tool for installing, replacing, adjusting and/or removing pedals and/or pegs on a cycle such as a bicycle. The tool comprises a handle portion and a head portion. The head portion further comprises a cutout with a tab and an opening. The cutout and tab permit the user to securely and removably engage a peg for a cycle, while the opening permits the user to securely and removably engage a pedal for securing or removing a pedal from the cycle. Furthermore, in the preferred embodiment of the present invention, the handle of the tool further comprises a grip for easy and secure handling of the tool.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the tool of the present invention.

FIG. 2 illustrates a front elevational view of the head portion of the tool of the present invention.

FIG. 3 illustrates a perspective view of an individual riding a prior art bicycle, with prior art pedals and prior art pegs installed thereon.

FIG. 4 illustrates a close-up perspective and partially exploded view of a prior art peg installed on the threaded axle of a prior art bicycle.

FIG. 5 illustrates a perspective view of the tool of the present invention engaging a cycle peg.

FIG. 6 illustrates a perspective partially exploded view of a prior art cycle gear, arm and pedal assembly.

FIG. 7 illustrates a perspective view of the tool of the present invention engaging a nut on a prior art cycle pedal installed on a cycle.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Most cycle owners have the periodic need to install, replace adjust and/or remove pedals and pegs on a cycle, such as a unicycle, bicycle, tricycle and the like, in a safe and timely manner. Heretofore, a single tool for performing these tasks did not exist, and individuals were oftentimes forced to use multiple common tools, such as wrenches and the like, which were not designed for this particular use and are therefore cumbersome, inefficient and time-consuming to use. A single tool that can be used to install, replace, adjust and/or remove pedals and pegs on a cycle would advance the art and help improve the cycling experience for all users, regardless of age or level of cycling experience.

Accordingly, the disclosed tool of the present invention provides a user with a single, relatively lightweight and easy to use device for installing, replacing, adjusting and/or removing pedals and pegs on a cycle, such as a unicycle, bicycle, tricycle and the like. The tool of the present invention can be used by all cycling enthusiasts, amateur and professional, regardless of age or physical characteristics, and can be readily and easily transported with a cycle.

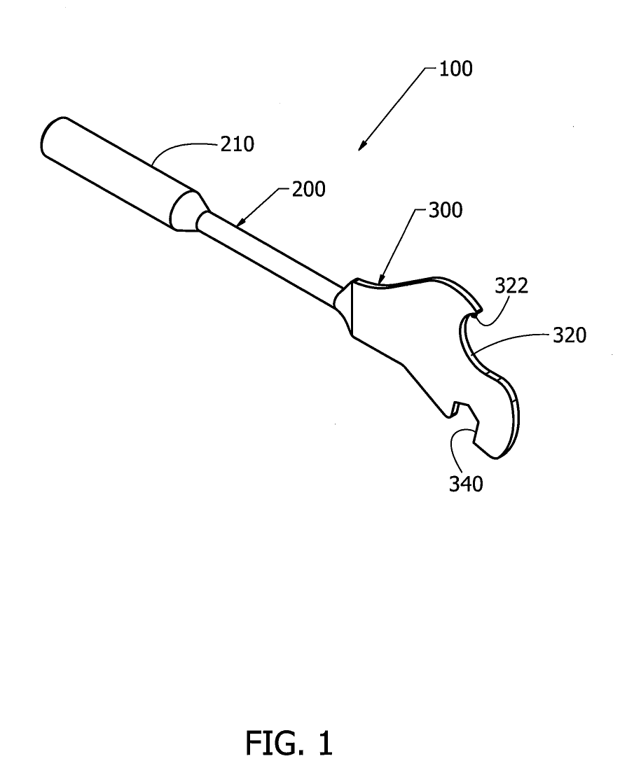

Referring initially to the drawings, FIG. 1 illustrates a tool 100 for installing, replacing, adjusting and/or removing pedals and pegs on a cycle, such as a unicycle, bicycle, tricycle and the like. The cycling tool 100 preferably comprises a handle portion 200 and a head portion 300. Handle portion 200 and head portion 300 can be of unitary construction or can be separately manufactured and permanently attached to one another by any means commonly known in the art.

In the preferred embodiment of the present invention depicted in FIG. 1, handle portion 200 is preferably an elongated member constructed from a durable material such as steel. However, it is also contemplated that other durable materials could be used without affecting the overall concept of the present invention such as iron, wood, plastic and the like. Handle portion is preferably between 9 and 14 inches long, and more preferably between 11 and 12 inches long, though it is contemplated that handle 200 can be of virtually any length provided that said length enables a user (not shown) to apply sufficient torque to install, replace, adjust and/or remove pedals and/or pegs on a cycle, such as a unicycle, bicycle, tricycle and the like, with minimal effort. Handle portion 200 may also further comprise a grip 210 on the outer surface of handle portion 200 as shown in FIG. 1 to ensure easy and secure handling of tool 100 by a user. Grip 210 is well known in the art and can be similar to those grips commonly used on other hand tools, such as hammers, screwdrivers, and the like.

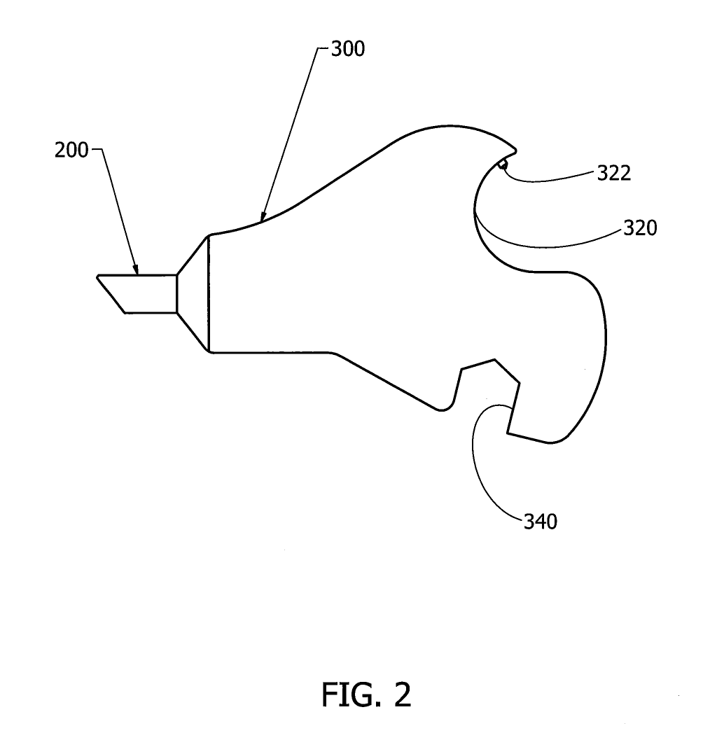

Head portion 300 is also preferably constructed from a durable material such as steel, though it is contemplated that other durable materials could be used without affecting the overall concept of the present invention such as iron, wood, plastic and the like. In the preferred embodiment of the present invention, head portion 300 of tool 100 further comprises a cutout 320 and an opening 340 as best illustrated in FIG. 2.

Cutout 320 is a generally semi-circular opening along the exterior of head portion 300 as best illustrated in FIG. 1, and further comprises a tab 322 for insertion into an opening on the exterior surface of a bicycle peg as described more fully below. Opening 340 is similar in shape to the opening on a prior art open ended wrench (not shown) and is also located along the exterior of head portion 300 as best illustrated in FIG. 1. More specifically, opening 340 should be shaped and of sufficient width to accommodate a mating engagement with a 15 mm hexagonal nut as explained more fully below to permit tool 100 to be used in a wrench like fashion in conjunction with a cycle pedal as explained more fully below, though it is contemplated that opening 340 could be shaped and of sufficient width to accommodate a mating engagement with virtually any sized nut.

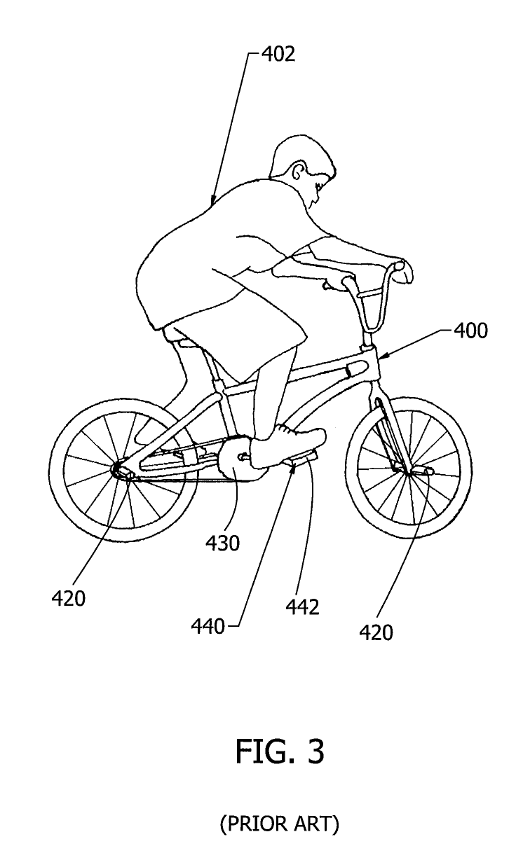

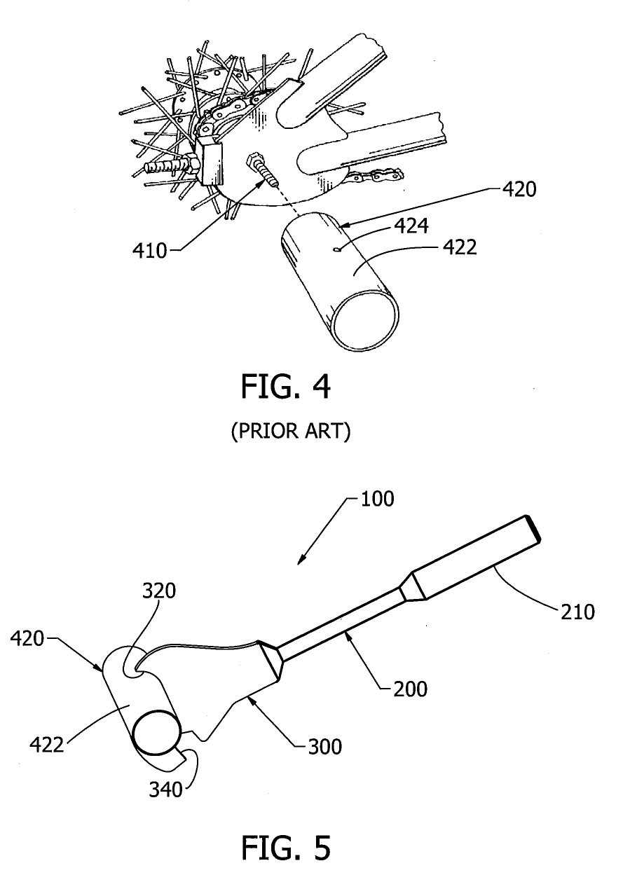

Now that the general overall structure of tool 100 has been described, its use will now be discussed with respect to both cycle pegs and pedals. By way of background, FIG. 3 illustrates a perspective view of an individual 402 riding a prior art bicycle 400 with prior art pedals 440 and prior art pegs 420 installed thereon. FIG. 4 illustrates a close-up perspective and partially exploded view of prior art peg 420 installed on a threaded axle 410 of prior art bicycle 400. Peg 420 is well known in the art and is generally cylindrical in shape and internally threaded to matingly engage a threaded extension on a cycle such as an axle as described in further detail below. More specifically, peg 420 typically comprises a threaded opening (not shown) on at least the end of peg 420 closest to the wheel of bicycle 400 when installed, and can be screwed on and off of threaded axle 410. Peg 420 further comprises an exterior surface 422 with at least one opening 424 located therein for matingly receiving tab 322 as best illustrated in FIGS. 4 and 5.

When individual 402 desires to removably attach prior art peg 420 to bicycle 400, individual 402 simply screws peg 420 onto threaded axle 410 in a clockwise direction. Once peg 420 is partially installed on threaded axle 410 by hand, individual 402 can use tool 100 to complete the installation by applying cutout 320 of head portion 300 to exterior surface 422 of peg 420 such that tab 322 is matingly engaged with opening 424. While tab 322 is matingly engaged with opening 424, individual 402 simply rotates handle portion 200 in a clockwise direction around axle 410 to securely fasten peg 420 onto threaded axle 410. Similarly, individual 402 can also use tool 100 to adjust, remove or loosen peg 420 from axle 410 by applying cutout 320 of head portion 300 to exterior surface 422 of peg 420 such that tab 322 is again matingly engaged with opening 424. While tab 322 is matingly engaged with opening 424, individual 402 simply rotates handle portion 200 in a counter-clockwise direction around axle 410 until peg 420 from threaded axle 410.

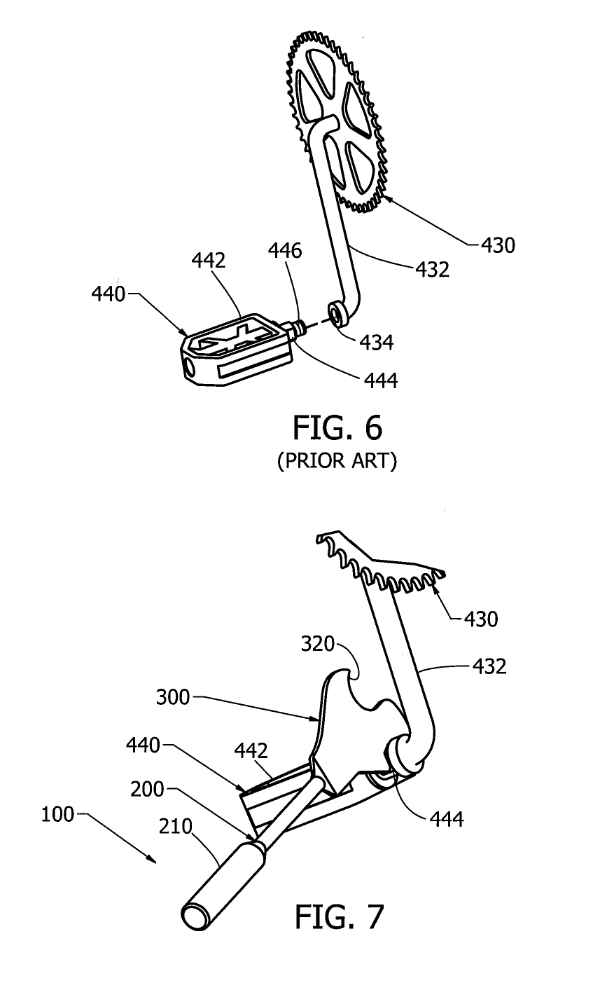

FIG. 6 illustrates a perspective and partially exploded view of a gear 430, arm 432 and pedal 440 of prior art bicycle 400 of FIG. 3. Each of gear 430, arm 432 and pedal 440, and their respective function on bicycle 400 and interaction with one another, are well known in the art. For example, the end of arm 432 that attaches to pedal 440 further comprises an internally threaded opening 434, and pedal 440 further comprises a step portion 442, a nut 444 adjacent and attached to step portion 442, and a threaded portion 446 adjacent and attached to nut 444 as best illustrated in FIG. 6. Threaded portion 446 is appropriate sized to matingly engage with internally threaded opening 434 and is used to removably attach pedal 440 to arm 432 as is commonly known in the art.

When individual 402 desires to use tool 100 to removably attach prior art pedal 440 to bicycle 400, individual 402 simply screws threaded portion 446 of pedal 440 into opening 434 of arm 432 in a clockwise fashion. Once pedal 440 is partially installed on arm 432 by hand, individual 402 can use tool 100 to complete the installation by matingly engaging opening 340 of head portion 300 to nut 444 of pedal 440 in a wrench like manner and rotating handle portion 200 in a clockwise direction around threaded portion 446 to securely attach pedal 440 to arm 432. Likewise, individual 402 can also use tool 100 to adjust, remove or loosen pedal 440 from arm 432 by again matingly engaging opening 340 of head portion 300 to nut 444 of pedal 440 in a wrench like manner and rotating handle portion 200 in a counter-clockwise direction around threaded portion 446 to loosen and/or remove pedal 440 from arm 432.

It is worth noting that while the forgoing described methodologies of using the tool of the present invention are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tool for installing, adjusting or removing a pedal or peg on or from a cycle comprising:
a handle portion; and
a head portion, wherein said head portion further comprises a cutout for engaging said peg, and where said cutout further comprises a tab for matingly engaging an opening in said peg.

2. The tool of claim 1, wherein the handle portion further comprises a grip.

3. The tool of claim 1, wherein said head portion further comprises an opening therein for engaging a pedal.

4. The tool of claim 1, wherein said head portion is comprised of steel.

5. The tool of claim 3, wherein said opening engages a nut on said pedal.

6. The tool of claim 1, wherein said peg is installed, adjusted or removed on or from an axle on said cycle.

7. A tool for installing, adjusting or removing a pedal or peg on or from a cycle comprising:
a handle portion;
a head portion, wherein said head portion further comprises an opening therein for engaging a pedal and a cutout for engaging said peg, and where said cutout further comprises a tab for matingly engaging an opening in said peg.

8. The tool of claim 7, wherein the handle portion further comprises a grip.

9. The tool of claim 7, wherein said head portion is comprised of steel.

10. The tool of claim 7, wherein said opening engages a nut on said pedal.

11. The tool of claim 7, wherein said peg is installed, adjusted or removed on or from an axle on said cycle.

12. A tool for installing, adjusting or removing a pedal or peg on or from a cycle comprising a head portion, wherein said head portion further comprises an opening therein for engaging a pedal and a cutout for engaging said peg, and where said cutout further comprises a tab for matingly engaging an opening in said peg.

13. The tool of claim 12, wherein said head portion is comprised of steel.

14. The tool of claim 12, wherein said opening engages a nut on said pedal.

15. The tool of claim 12, wherein said peg is installed, adjusted or removed on or from an axle on said cycle.
